(19) United States
(12) Patent Application Publication
(10) Pub. No.: US 2026/0097484 A1
(43) Pub. Date: Apr. 9, 2026

(54) EXOSKELETAL NETWORK FOR ELASTIC TORQUE ASSOCIATED WITH THE JOINT

(71) Applicant: REHABILITATION INSTITUTE OF CHICAGO, Chicago, IL (US)

(72) Inventors: James L. Patton, Chicago, IL (US); Valentino Wilson, Chicago, IL (US); Leah O'Shea, Chicago, IL (US); Partha Ryali, Chicago, IL (US); Courtney Celian, Chicago, IL (US); Charles Okonma, Chicago, IL (US)

(21) Appl. No.: 19/353,344

(22) Filed: Oct. 8, 2025

Related U.S. Application Data
(60) Provisional application No. 63/704,867, filed on Oct. 8, 2024.

(51) Int. Cl. B25J 9/00; A61H 1/02; B25J 9/10; B25J 9/16; B25J 13/00

(52) U.S. Cl. CPC B25J 9/0006; A61H 1/024; A61H 1/0244; A61H 1/0266; A61H 1/0277; A61H 1/0285; B25J 9/104; B25J 9/1664; B25J 13/00

(57) ABSTRACT

A system for joint movement assistance and therapy includes: a wearable joint movement device attached noninvasively to a user and a data processing device. The wearable joint movement device includes a first band removably attached on a limb of a user proximal of a first joint of the user; a second band removably attached on the limb of the user distal of a second joint of the user; and actuator element(s). The data processing device collects data indicative of a torque deficit of the limb of the user; measurement data of the limb of the user; and a desired torque profile for the wearable joint movement device; and generates, based on the data indicative of a torque deficit of the limb of the user, the measurement data and the desired torque profile, and using mathematical model(s), instructions for selecting a configuration of the actuator element(s).

### CROSS REFERENCE TO RELATED APPLICATION

This application claims benefit to U.S. Provisional Application No. 63/704,867, filed Oct. 8, 2024, which is incorporated herein by reference in its entirety for all purposes.

### GOVERNMENT SUPPORT CLAUSE

This invention was made with government support under Grant No. RERC #90REGE0017 awarded by National Institute on Disability, Independent Living, and Rehabilitation Research (NIDILRR). The government has certain rights in the invention.

### FIELD

The present disclosure relates generally to joint movement therapy and assistive devices, more specifically to wearable devices for joint movement therapy..

### BACKGROUND

One of the primary functions of the arm is to properly position and stabilize the hand to perform tasks such as activities of daily living (ADL). The orientation of the hand with respect to the target object or tool is critical to successful completion of these ADLs. Stroke leads in the causes of major long-term neurologic disability, and the most common and disabling sensorimotor impairments include the inability to grasp and handle objects. Stroke typically affects both proximal and distal motor units, thereby compromising the ability to position and orient the hand. Control of forearm supination may be especially diminished, thereby limiting the ability to effectively manipulate or grasp objects. Reduction of arm function often results in compensatory strategies that lead to muscle imbalances and injury. Decreased arm function also can lead learned non-use, a vicious cycle of further reduced muscle strength and secondary effects such as contracture.

While some clinical trials investigating post-stroke therapeutic interventions (e.g., EXCITE and ICARE) demonstrated improvements on clinical scores, substantial deficits remained. Such deficits most radically impact bimanual tasks. Reduced forearm pronation/supination is critical and is often compounded by deficits in nearby joints, where unwanted synergies cause unintended actions of the forearm when using the elbow. Additionally, reductions in forearm range of motion (ROM) affect hand positioning and strength when reaching and grasping tools and objects. One has only to consider how much we use our forearm in daily life to understand how such deficits substantially impact employment opportunities and self-care.

Therapeutic efforts to remediate the forearm and wrist, while promising, often do not lead to full recovery, leaving many adults with life-long deficits. Technology has the potential to increase ability and decrease the physical and emotional burden of care and lower health care costs. Despite the potential for technology to enhance functionality and reduce the physical and emotional strain of care, as well as healthcare expenses, the field of rehabilitation technology has not given equal emphasis to hand orientation as it has to hand location. Practical devices that support supination and encourage everyday use are scarce, particularly those that are suitable for uncontrolled environments, aesthetically pleasing, capable of facilitating real-life activities, easy to use and wear, and lightweight and comfortable for extended periods.

While other devices that provide supination assistance exist, these devices are not suitable for uncontrolled environments, are not aesthetically pleasing or easy to use. Additionally, no device exists that can provide both assistive and therapeutic torques to the forearm during a single supination movement. Most devices are aimed at achieving one or the other, but not both, and not both in a single supination movement. The available devices that are suitable for uncontrolled environments include motors, batteries, and actuators that require complex calibrations, charging, and all the user-experience constraints that come with bulkier, heavier, and more complex devices. These devices are often too daunting for clinicians to use, and therefore end up either sitting on a shelf or remain unused on the clinical floor. While other less intimidating, passive devices exist, they are typically not suited for uncontrolled environments, meaning that they require the user to sit and use it in a stationary way. These devices are not able to be worn or taken with the user to assist them during daily activities. These devices typically use passive stretching as the main form of assistance.

Further, stroke often results in persistent lower-extremity motor impairments, including abnormal gait patterns and muscle weakness. Current gait devices targeted towards stroke are often costly, invasive, and complex. Motor-powered exoskeletons can improve foot clearance but tend to be heavy, require extensive setup with multiple sensors and cables, and may limit voluntary muscle activation which limits muscle engagement and strength development. Effective motor recovery relies on skill acquisition, a function of assistance and error augmentation (EA), progressing from guided or assist-as-needed training toward independent practice, during which errors are intentionally amplified to enhance motor learning. Motor learning can occur when assistance is reduced, and difficulty is increased through error amplification.

As such, a need remains for limb assistive technology that can improve upper extremity function following stroke by providing both assistive and therapeutic torques to the limb during a single rotation (e.g., supination) movement, and that is simultaneously suitable for uncontrolled environments, aesthetically pleasing, easy to use, inexpensive, lightweight, and unintimidating. Further, a need exists for an algorithm capable of recommending a configuration for the device that will be tailored to meet the specific needs of a particular user. There is great potential for such a tool in the clinic, community treatment centers, rehab gyms, and the home.

### SUMMARY

The disclosure relates to wearable devices designed to assist and improve limb and joint movement utilizing networks of passive, multi-joint elastic actuators to generate the desired joint torque in multiple degrees of freedom, along with novel algorithms for tailoring the network of actuators to meet the unique requirements of each user. In one example, the device may be designed to address forearm supination, particularly for hemiparetic stroke survivors. Disclosed herein are novel systems for joint movement assistance and therapy, the system comprising: a wearable joint movement device attached noninvasively to a user and a data processing device. In one example, the wearable joint movement device comprises: a first band, configured to be removably attached on a limb of a user proximal of a first joint of the user; a second band, configured to be removably attached on the limb of the user distal of a second joint of the user; and at least one actuator element. When connected at a first end to the first band and at a second end to the second band, the at least one actuator element is configured to generate a torque profile between the first band and the second band such that the limb portion of the user in motion is in one or both of a state of stable equilibrium and a state of unstable equilibrium. In one example, the at least one actuator element is configured to generate a torque profile between a wrist band and a forearm band such that the forearm of the user moving in supination is in one or both of a state of stable equilibrium and a state of unstable equilibrium.

The data processing device is configured to collect data indicative of a torque deficit of the limb of the user; collect measurement data of the limb of the user; collect a desired torque profile for the wearable joint movement device; and generate, based on the data indicative of a torque deficit of the limb of the user, the measurement data and the desired torque profile, and using at least one algorithm, instructions for selecting a configuration of the at least one actuator element.

Also disclosed herein are methods, such as computer-implemented methods, for joint movement assistance and therapy comprising: providing a wearable joint movement device configured to be attached noninvasively to a user and providing a data processing device. The wearable joint movement device, in one example, may comprise a first band, configured to be removably attached on a limb of a user proximal of a first joint of the user; a second band, configured to be removably attached on the limb of the user distal of a second joint of the user; and at least one actuator element. When connected at a first end to the first band and at a second end to the second band, the at least one actuator element is configured to generate a torque profile between the first band and the second band such that the limb portion of the user in motion is in one or both of a state of stable equilibrium and a state of unstable equilibrium. The data processing device is configured to collect data indicative of a torque deficit of the limb of the user; collect measurement data of the limb of the user; collect a desired torque profile for the wearable joint movement device; and generate, based on the data indicative of a torque deficit of the limb of the user, the measurement data and the desired torque profile, and using at least one algorithm, instructions for configuring the at least one actuator element. The method may further include the step of, based on the instructions, connecting the first end of the at least one actuator element to the first band and a second end of the at least one actuator to the second band.

The following disclosure suggests an alternative to motors and other powered devices, namely the use of spring elements without a rigid skeleton. The novel joint movement device described herein is a passive, multi-joint device that relies on the user's skeleton and requires no rigid links. Most importantly, each tension element generates a sinusoidal torque profile that is shaped by the geometry. These profiles act mathematically as basis functions that can be linearly combined to achieve any desired torque profile, when tuned via optimization. Devices incorporating spring elements can also intelligently recycle energy and do not require motors, controllers, sensors, or power.

Further, the disclosed joint movement device also addresses the multi-joint synergy problem typically seen in the hemiparetic stroke patient population. Voluntary forearm supination is not only limited in stroke, but this deficit is also coupled with and exacerbated by involuntary shoulder movements such as those associated with an unwanted synergy. The multi-joint spring-like properties of the disclosed designs can couple and “re-bias” the system so that as the elbow extends and typically causes unwanted pronation, the joint movement device can provide a supination torque.

The foregoing examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the embodiments of the disclosure and are incorporated in and constitute a part of this specification, illustrate examples, and together with the description serve to explain the principles of the disclosure.

FIGS. 1A-1C illustrate an exemplary joint movement device according to embodiments disclosed herein;

FIGS. 2A-2B illustrate an exemplary joint movement device according to embodiments disclosed herein;

FIGS. 3A-3B illustrate an exemplary joint movement device according to embodiments disclosed herein;

FIGS. 4A-4B illustrate an exemplary joint movement device according to embodiments disclosed herein;

FIGS. 5A-5C illustrate an exemplary joint movement device according to embodiments disclosed herein; and

FIG. 6 is a schematic diagram of a system for joint movement assistance and therapy according to embodiments disclosed herein;

It should be understood that some of the drawings and replicas of the photographs may not necessarily be shown to scale, unless otherwise indicated. In certain instances, details that are not necessary for an understanding of the disclosure or that render other details difficult to perceive may have been omitted. It should be understood, of course, that the disclosure is not necessarily limited to the particular examples or embodiments illustrated or depicted herein.

### DETAILED DESCRIPTION

### Definitions and Terminology

This disclosure is not meant to be read in a restrictive manner. For example, the terminology used in the application should be read broadly in the context of the meaning those in the field would attribute such terminology. Persons skilled in the art will readily appreciate that the various embodiments of the inventive concepts provided in the present disclosure can be realized by any number of methods and apparatuses configured to perform the intended functions. It should also be noted that the accompanying figures referred to herein are not necessarily drawn to scale, but may be exaggerated to illustrate various aspects of the present disclosure, and in that regard, the figures should not be construed as limiting. Some figures do, however, represent anatomy and the positioning of embodiments relative to that anatomy and such representations should be understood to be scaled and positioned accurately, with some deviation permitted as the anatomical structures depicted will vary in size and position from person to person.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

### Description of Various Embodiments

The present disclosure relates to systems, devices, and methods for assisting and improving limb and joint movement for individuals with mobility deficits, such as post-stroke individuals, as further explained herein. The novel system, device and methods disclosed herein provide the desired user experience of passive devices, while offering features that improve upon the performance of the more complex active devices. This balance may reduce the barrier of access and, thereby, increase clinician uptake and adoption of the device.

The customizable wearable joint movement device described herein may be used as an assistive orthotic, for example, to aid in achieving forearm supination control and subsequent hand positioning to manipulate objects during ADLs. Additionally, this device can be used therapeutically to strengthen the muscles of interest, such as the supinator muscles, and foster coordination by providing resistance at certain points in the range of motion (ROM). The device may provide these benefits to many populations with motor-neural limitations, including post-stroke individuals with hemiparesis, tetraplegic individuals with spinal cord injury, and individuals with amyotrophic lateral sclerosis (ALS). The device can accomplish these behaviors by exploiting the principles of stable and unstable equilibrium using a network of passive elastic actuators to generate a variety of clinician-specified patterns of multi-joint torque. A stable equilibrium in the case of the disclosed device can provide constant assistance or resistance throughout the full range of motion of the user. An unstable equilibrium in the case of the present device can provide resistance throughout the user's active range of motion and transitioning to assistance upon reaching their movement limit, thus ensuring completion of the full range of motion.

A user's unique torque deficits can be determined by measuring static supination torque at several positions, active supination torque, active supination range of motion, passive supination range of motion at various rotational speeds, grip strength, and spastic catch position. A clinician can use these metrics, user measurements (including forearm length and diameter), and other information to generate a treatment plan and select the most appropriate size of the device and number and configuration of the actuators for the wearer. Alternatively, these user metrics can be provided to a mathematical optimization model for tailoring the number and arrangement of the actuators on the device to meet each user's needs and/or to achieve goals set by the user, a clinician or both, for example by optimizing a configuration of at least one actuator element on the wearable joint movement device to achieve a desired torque profile. Each actuator element of the device generates a sinusoidal torque profile that functions mathematically as basis functions, which can be linearly combined to achieve any desired torque profile through tuning via optimization.

The figures illustrate several example configurations of the wearable joint movement device, or a wearable device 100, including two bands (first band 102 and second band 104) disposed on a limb segment and one or more actuators 106 operably coupled with the first 102 and second 104 bands. The first band 102 is worn at a first location on the limb segment proximal of (above) a first joint, and the second band 104 is worn at a second location on the limb segment that is different from the first location and distal of (below) a second joint that is different from the first joint. In one example, the first band 102 may be a wrist band positioned on the forearm proximal of (above) the wrist joint (first joint)and the second band 104 may be a forearm band positioned on the forearm distal of (below) the elbow joint (second joint).

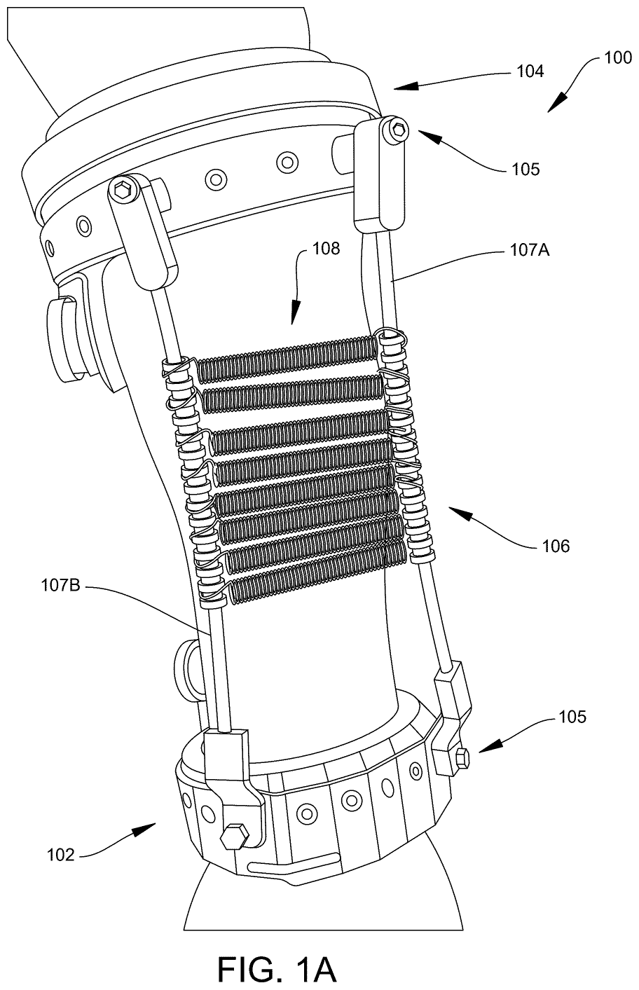

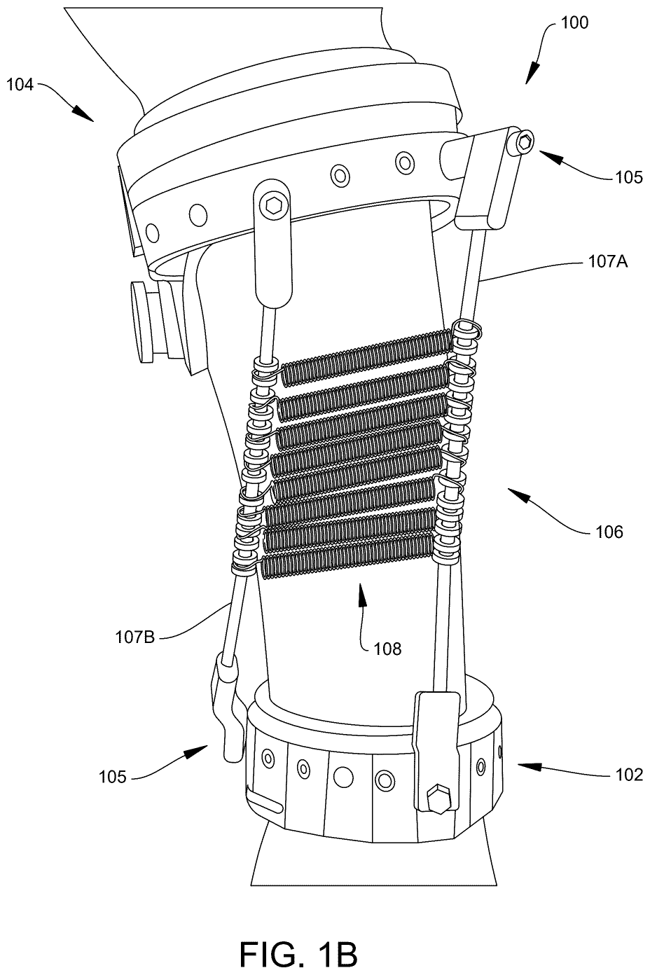

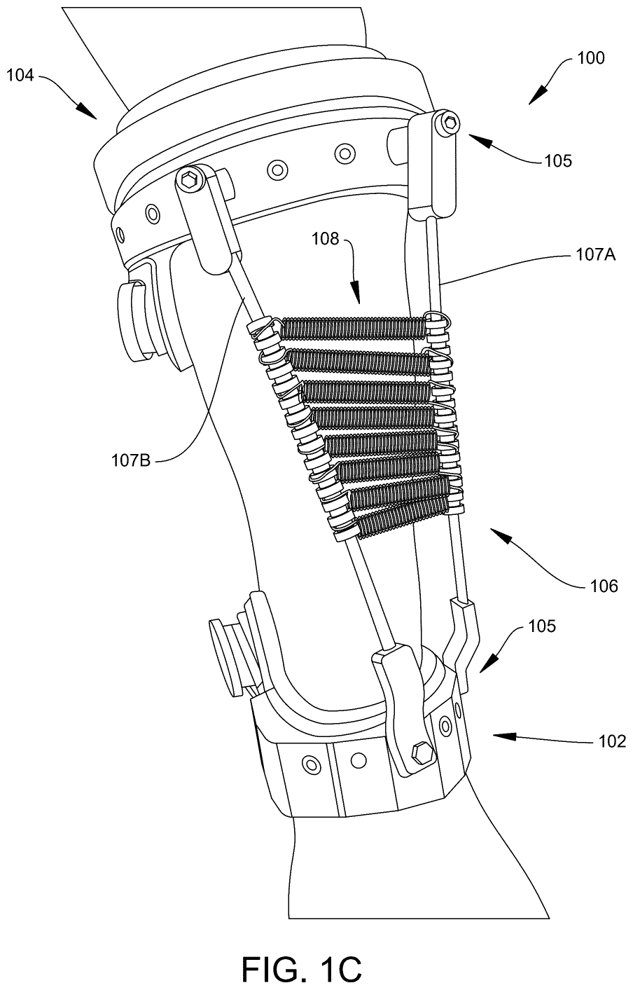

The bands may be 3D printed from Thermoplastic Polyurethane (TPU) using Fused Deposition Modeling (FDM). Other materials and fabrication methods are contemplated. The bands 102, 104 serve to connect the wearable device 100 to the limb segment of the user and as anchoring points for the actuators of the device, and may be provided in any form capable of meeting these purposes. As such, the bands may include one or more connectors 105 for anchoring the actuator(s) 106, such as rail or a screw connectors that are common to both of the bands. Further, in some examples, the wearable device 100 may include more than two bands. Different connectors may be used, based on the type of actuator 106 and the band being connected to. In the example illustrated in FIG. 1A, for example, the connectors slide around the rods and allow them to pivot with 180 degrees of rotation similar to a 2-dimensional hinge joint. On the first band, different connectors may be used for each actuator type, but all have the same base of either a screw or rail attachment. The elastic cords may have a custom barbed hose fitting that grips the elastic cord element and anchors it to the band while again allowing rotation like a hinge or ball joint.

Various sizes of the joint movement device 100, such as small, medium, and large versions, may be provided. Each size device may include actuators of various lengths, diameters, and stiffnesses. Certain preset sizes and configurations of the movement device may be known or developed by clinicians or therapists to achieve optimal wearer results based on certain wearer metrics, including the wearer's measurements, torque deficits, and needs and therapeutic goals and/or assistance needs as determined by a clinician. These preset configurations may be developed organically (e.g., by trial and error) in a clinical setting, or through research.

The joint movement device 100 may include one or more actuator(s) 106 which can be selected and aligned in different configurations to dictate how they interact with each other. In some examples, the actuator(s) 106 may include one or more of: rod actuators, elastic (bungee) cord actuators, and/or tension springs, which should be understood to mean, the device may include only a rod actuator, only an elastic cord actuator, only a tension spring, or a combination of one or all of a rod actuator, an elastic cord actuator and a tension spring. In some examples, a first actuator may be connected at a first end of the first band 102 and at a second end to the second band 104, and a second actuator may be connected at a first end to the first band 102 and at a second end to the second band 104. In some examples, the first actuator may be laterally spaced apart from the second actuator. The type(s), positioning and characteristics of (e.g. length, stiffness) of the actuator utilized in the particular configuration of the device may be customized to achieve the assistive and/or resistive (therapeutic) requirements of the wearer.

Elastic cord actuators may configure the device in a state of stable equilibrium, where either full assistance or full resistance is provided throughout the wearer's full supination range of motion. The cord actuator can be combined with additional actuator configurations to bias the device movement towards full assistance or resistance during supination. In this way, the unstable equilibrium behavior of the fiberglass rods and the stable equilibrium behavior from the elastic cord can both be exploited. In some examples, the cord actuator may be connected at a first end to the first band and at a second end to the second band and wrapped at least one time around the forearm of the user therebetween.

Rod actuators may be used to provide the device an unstable equilibrium around the forearm. In some examples, the rods are constructed of fiberglass. Rods of various lengths, diameters and stiffnesses may be selected to achieve the desired torque profile. In operation, the unstable equilibrium provides a resistive torque at the joint (e.g., wrist) during a wearer's active supination range of motion. However, once the wearer is at their maximum active range of motion, the device provides an assistive torque to allow the wearer to reach full supination. The concept of an unstable equilibrium during supination of the forearm can be likened to a person walking up and then down a hill. As the person walks up the hill, i.e., begins to supinate the forearm, this is analogous to a resistive torque being applied at the joint (wrist). The top of the hill is analogous to the point of maximum active range of motion. Any further advance motion, i.e., further supination, will result in rolling down the hill, which is analogous to providing an assistive torque at the joint (wrist). The novelty of being able to grant both resistance (therapy) and assistance during a single motion allows the wearer to functionally use their hand during ADLs that require full supination, while providing the ability to expand the active supination range of motion.

Some exemplary configurations of the joint movement device 100 are illustrated in the Figures. Additional configurations are contemplated. While the Figures illustrate embodiments of the joint movement device 100 worn on the forearm of a user, the device and its principles may be applied to other limb segments and joints. Further, the joint movement device 100 may, in some examples, be configured to apply to multiple adjacent limb segments and joints, such as the wrist, elbow and shoulder or the ankle, knee and hip. FIGS. 1A-1C illustrate an example of the device 100 in a shutter rod configuration, inspired by the shuttering behavior of a camera lens. The shutter configuration includes a plurality of actuators 106, including at least two rod actuators 107A and 107B and one or more tension spring elements 108. The at least two rod actuators 107A, 107B are rigid and unable to deflect with loads perpendicular to its length. Along the length of the rod actuators are attachment points for the one or more tension spring elements 108, connecting the adjacent rods together. In operation, as the joint (wrist) rotates from a first position to a second position (e.g., from full pronation to full supination), the rod actuators also move in a way that causes the springs to initially extend (as shown in FIG. 1B), inducing a resistive torque at the joint (wrist). At a certain point in the range of motion between the first position and second position, the springs begin to contract (as shown in FIG. 1C), inducing an assistive torque at the joint (wrist). This behavior induced by the interactions between the tension spring elements 108 and rod actuators 107A, 107B, allows for the device to provide the unstable equilibrium that is required for providing an assistive and therapeutic torque profile on the joint (wrist).

The point in the range of motion where resistive torque of the joint movement device 100 switches to assistive torque can be optimized for each user. As described above, a clinician will identify if and where a subject's “catch” is, or the point of sudden contracture in the subject's muscles as they try to move a limb segment from a first position to a second position (e.g., supination of the forearm). This is the point where the subject can no longer move or rotate the limb segment, such as the forearm (e.g., the end of their active supination ROM) and where the device needs to shift from resistance to assistance. In the example of a joint movement device 100 applied to the forearm, due to the unique properties of the spring elements 108 in combination with the ellipsoid shape of the human wrist, as the wrist rotates the rods, the springs either try to move away from each other or come closer to each other as the wrist supinates. This behavior of the mechanism can be highlighted and used to create the assistive and resistive torques. In some examples, by connecting spring elements between rigid rod elements, which serve as extension points of the forearm, when the rods want to move further from each other, the springs will extend and therefore induce a resistive force/torque on the wrist making supination harder. However, as the user continues to rotate their forearm and the rod elements start to get closer to each other, the springs will release their stored energy from expanding and cause an assistive force/torque on the wrist, helping the user reach full supination. The point where this shift from resistance to assistance can be optimized, based on selection and positioning of the actuator elements, to accommodate different impairment levels and goals of the therapy.

The device can accommodate greater than two actuator elements, however, as the amount of rod actuators increase, the device transparency decreases, causing restrictions in arm range of motion. If correctly calibrated, this issue may be alleviated, however, correct calibration becomes more difficult as the number of rod elements increase.

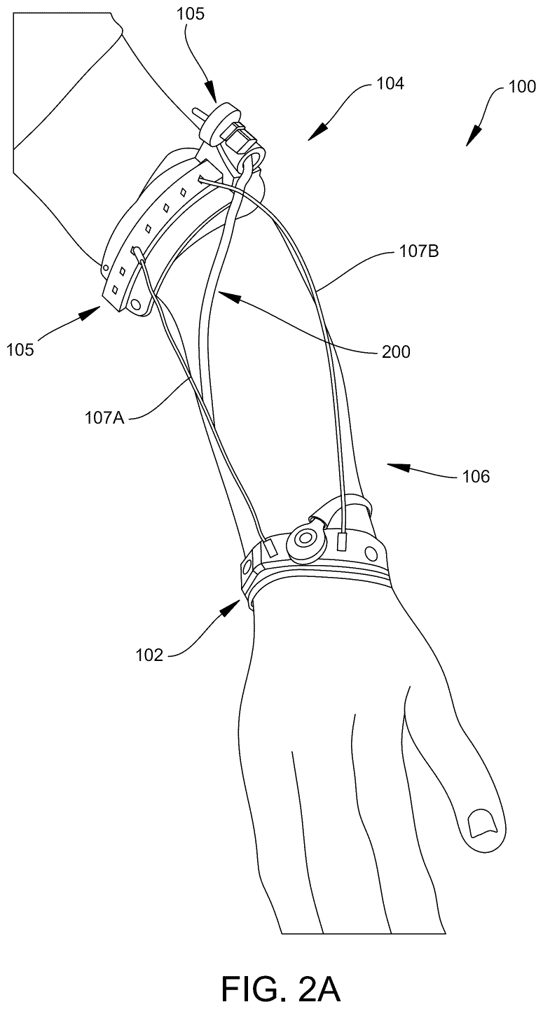

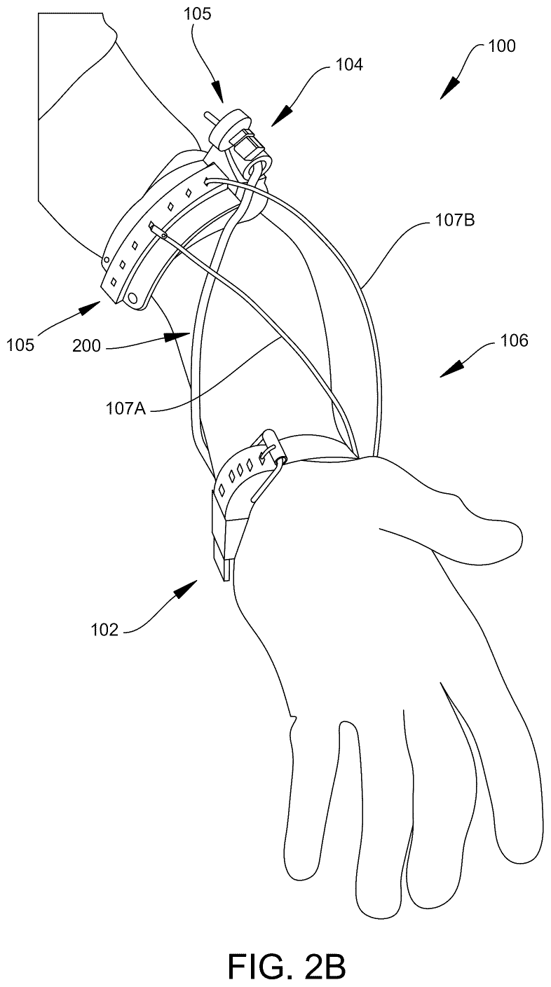

FIGS. 2A-2B illustrate an example of the device 100 in a bow spring configuration including a first band 102, a second band 104 and one or more actuators 106. In this configuration, the connector 105 comprises a grid of holes is embedded into the first band 102 and the second band 104. One or more rod actuators 107A, 107B extend from the second band to the first band, with attachment points similar to pegs and holes. The grid-like construction of the bands enables easy placement and re-placement of the rod actuators 107A, 107B to fit the necessary torque profile of the user. Other mechanisms for connecting the rod actuators 107A, 107B to the first band 102 and the second band 104 are contemplated.

In operation, the one or more rod actuators 107A, 107B bend like a bow, between the first band and second band, with their point of maximum deflection occurring somewhere along the midpoint of each rod's length. With this configuration, the rod actuators 107A, 107B protrude outwards from the limb segment (e.g., the forearm). Multiple rod actuators (e.g., rod actuators 107A and 107B as shown in the figures) can be placed around the forearm to accommodate the torque requirements of the individual. One or more cord actuators 200 may also be provided, wrapped around the limb segment (e.g., the forearm) in a helical configuration and secured at either end to one of the bands 102, 104.

As the first joint (e.g., wrist) rotates (e.g., supinates) from a first position, the rod actuators 107A, 107B are forced to bow further (as shown in FIG. 2B), thus storing more energy and resisting the rotation (e.g. supination) motion. This resistance provides the therapeutic force/torque. At a certain point in the ROM, which can be determined by the optimization algorithm described herein, the bow-spring will no longer be compressed and further rotation of the joint (wrist) will allow the bow-spring to try to return to its undeformed state. This releasing of the energy will provide an assistive force/torque on the joint (wrist), allowing the subject to reach the second position (e.g., a fully supinated state). In this configuration, unstable equilibrium is utilized by the bow-spring harnessing and releasing energy from the bowing and straightening of the bow-spring.

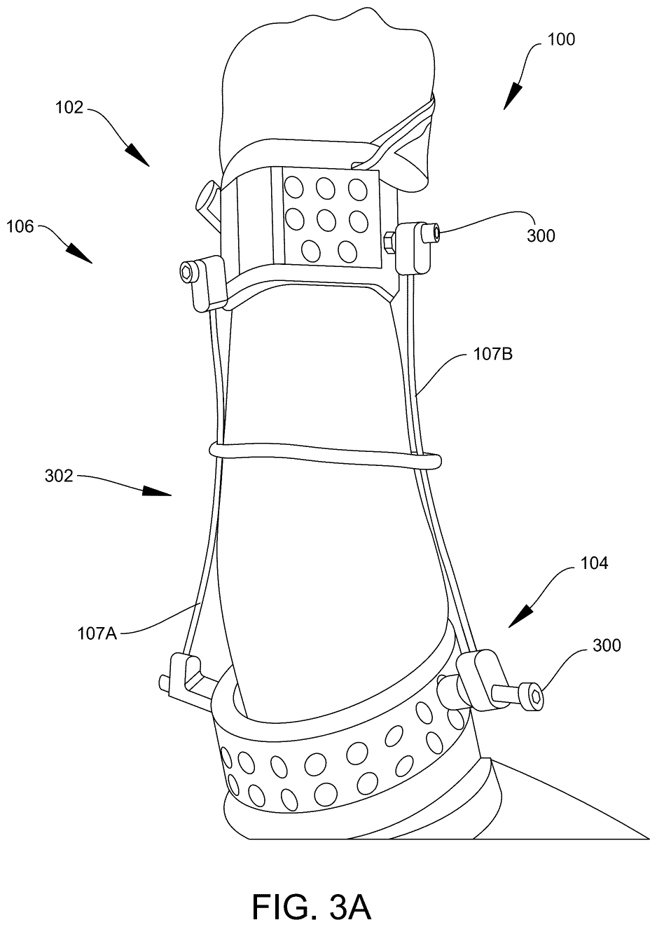

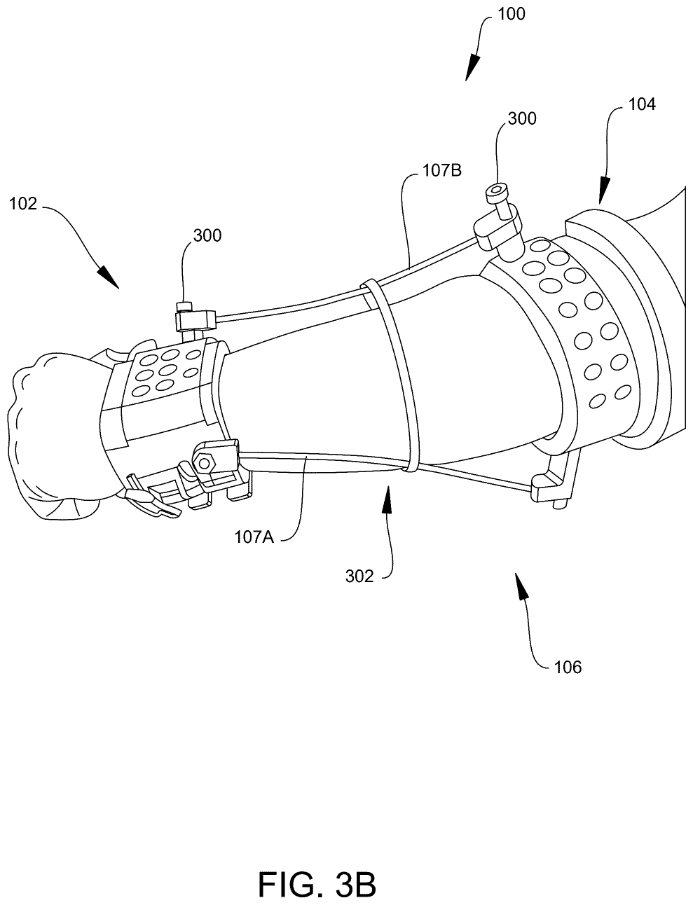

FIGS. 3A-3B illustrate an example of the device 100 in a simply supported rod configuration, inspired by a deflected simply supported beam found in many truss systems. This configuration uses one or more rod actuators 107A, 107B that are free to deform with loads perpendicular to their length. Each rod is connected to the first and second bands 102 and 104, via supports 300 of varying heights. A rigid band 302 is wrapped around the forearm and rod actuator(s) at the midpoint of the rod length to induce deflection of the rod(s) 107A, 107B. The extent of deflection is controlled by the clinician/user during device setup. During the user's active rotation range of motion, the rotation of the joint (wrist) causes the rod to deflect further (as illustrated in FIG. 3B), thus inducing a resistive torque at the joint (wrist). Once the user reaches a pre-defined point in their range of motion, the rod ceases to deflect and instead attempts to return to its undeformed state. This induces an assistive torque on the joint (wrist), causing the ability to reach full supination. It is important to note that in this configuration, the band 302 is rigid and controls actuation via establishing a minimum amount of deflection of the rod.

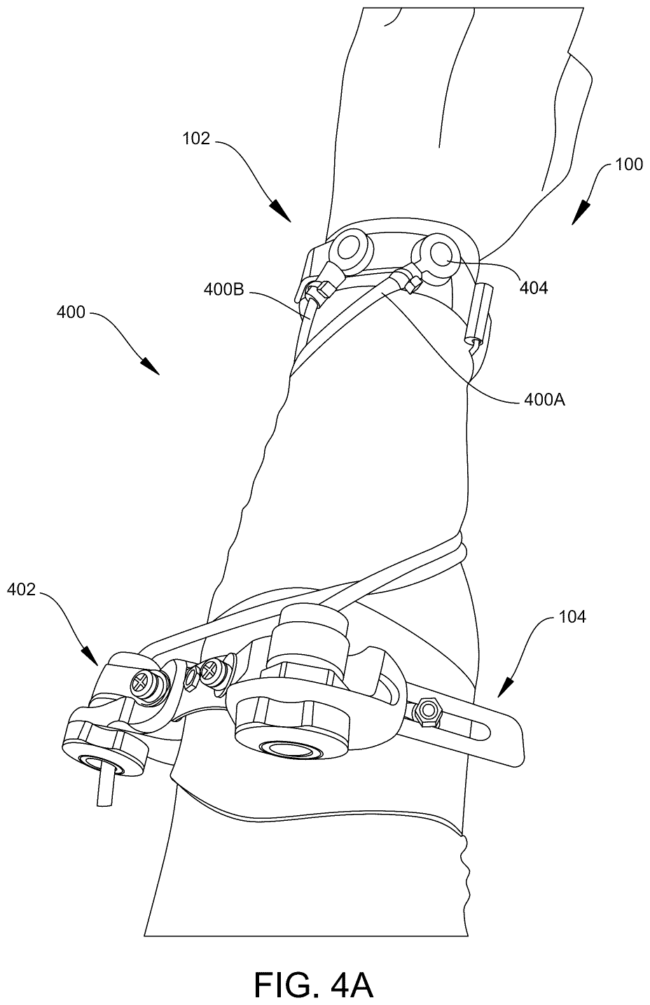

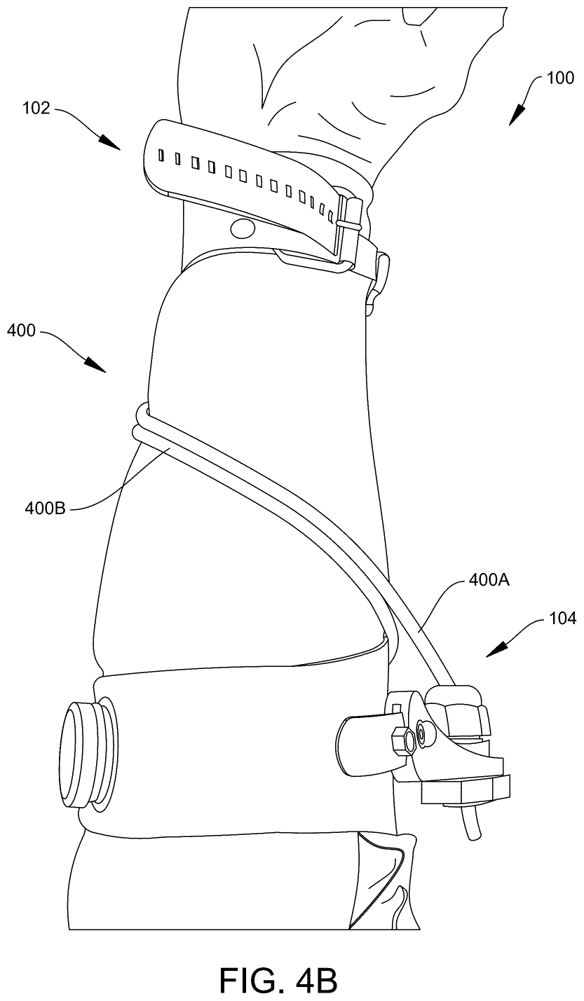

FIGS. 4A-B illustrate helical bungee configurations of the device 100 wherein the actuator(s) 106 includes one or more elastic cord actuators 400. In this configuration, one or more elastic cord actuators 400A and 400B may extend from the second band 104 to the first band 102 while wrapping helically around the limb segment (e.g., forearm) in between the bands. Increasing the offset can also have impacts on the torque producing capacity of the cord 400. The elastic cord actuators 400 may connect to the second band 104 using a rail connector 402 on the band 104. Once connected to the rail connector 402, the elastic cord 400 may attach into either a cord grip connector or a cam cleat connector 404, which allows the tension of the elastic cord 400 to be modified in real-time.

In this example, the elastic cord 400 wrapped around the forearm in a helical configuration provides a stable equilibrium. In this configuration, when the joint (e.g., wrist) is in a first position (e.g., a fully pronated state) as shown in FIG. 4A, the elastic cord is pulled taught. As the subject attempts to move the limb segment from a first position to a second position (e.g., supinate the forearm) as shown in FIG. 4B, the elastic cord 400 will release its energy and assist the rotation (e.g., supination) throughout the ROM to the second position. The level of assistance will decrease as the limb segment rotates (e.g., forearm supinates) to greater degrees, however, multiple elements can be used to ensure that a constant rotation assistive torque is applied throughout the ROM. The optimization algorithm described herein can be used to select and place the actuator elements in this configuration to provide the desired assistive and resistive torques.

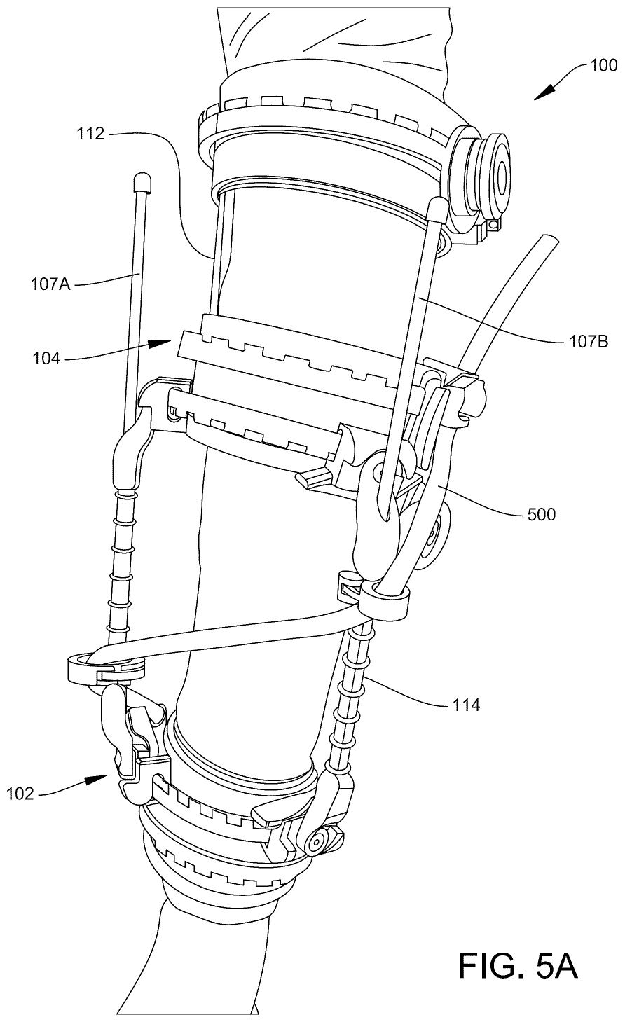

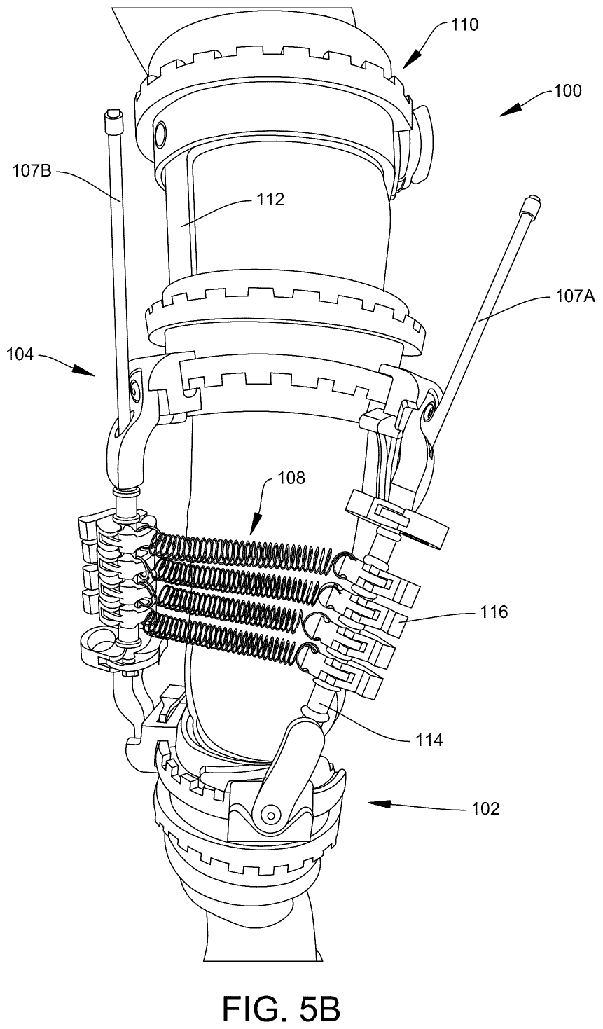

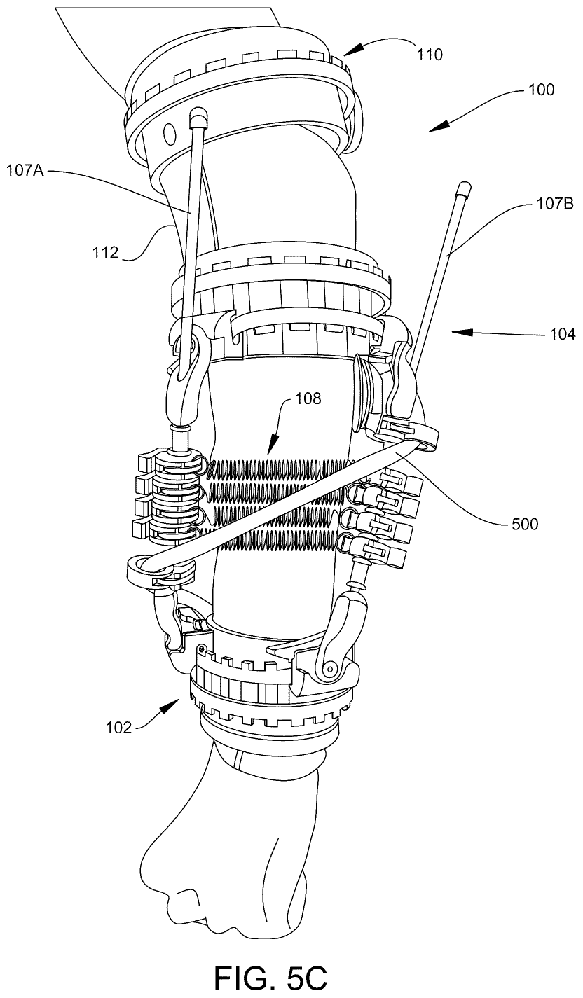

FIGS. 5A-C illustrate the device 100 with a first band 102 positioned proximal (above) a first joint (e.g., the wrist), a second band 104 and a third band 110 which may be removably attached proximal (above) the second joint, such as an elbow, of the user and one or more actuators 106. The third band 110 may be attached to or coupled with the second band 104 using a flexible bridge 112 extending therebetween configured to bend with the second joint (e.g., elbow). The addition of the third band 110 and bridge 112 serves to reduce skin artifact or skin movement while the device 100 is transmitting forces to the first joint (e.g., wrist) from the actuators 106. The bridge 112 may be made of any flexible material, such as TPU.

In the example shown in FIG. 5A, the one or more actuators 106 of the device 100 includes one or more rod actuators 107A, 107B and one or more elastic cord actuators 500. The helical wrapping configuration of the cord actuator 500 can be offset from the body to avoid interactions with the skin. The cord actuator 500 may be wrapped around the outside of the one or more rod actuators 107A, 107B to facilitate the offset. In some examples, the rod actuators 107A, 107B may have a length that extends beyond the second band 104 for adjustability of the length of the device 100. In some examples, the rod actuators 107A, 107B may be disposed at least partially within a rod sleeve 114. In some examples, the spring elements 108 may be attached to or coupled with the rod actuators 107A, 107B via spring collars 116 as the connectors. Rod sleeve 114 provides stationary anchors on the rod actuators 107A, 107B so that the spring collars 116 stay in a fixed position. The rod actuators 107A, 10B may be rotatably coupled with the first band 102 and slidably coupled with the second band 104 such that the distance between the first band 102 and the second band 104 may be adjusted to accommodate for users with different heights and limb lengths.

In the example illustrated in FIG. 5B, the one or more actuators 106 of the device 100 include one or more rod actuators 107A, 107B and the spring elements 108 according to embodiments, thereby leveraging the shutter configuration as disclosed herein. FIG. 5C shows an example of the device 100 wherein the one or more actuators 106 include the one or more rod actuators 107A, 107B, the elastic cord actuator 500, and the spring elements 108 according to embodiments, thereby incorporating both the helical bungee configuration and the shutter configuration as disclosed herein.

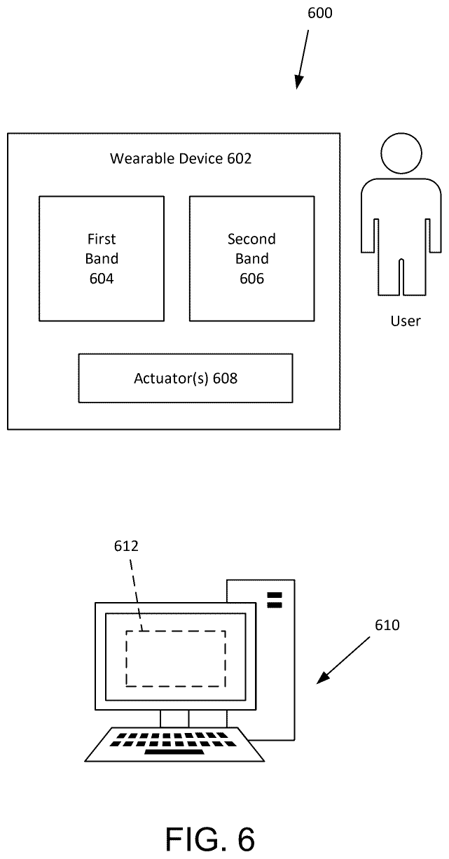

FIG. 6 illustrates a system 600 for joint movement therapy and assistance, including a joint movement wearable device 602 including a first band 604, a second band 606, and at least one actuator 608, as described herein, and a processing device 610 configured to execute an algorithm for generating a configuration of the at least one actuator based on data indicative of a wearer's joint movement capability and at least one requirement of the wearer. The processing device 610 may include a graphical user interface (GUI) 612 that receives user inputs to facilitate operation and optimization of the device 602 for example to adjust the number, selection and positioning of the bands and the one or more actuators 608 as disclosed herein. In some examples, each of the first band 604 and the second band 606 are positioned on different locations of a limb, each proximal to a joint, such as a wrist, elbow, shoulder, ankle, knee and hip. In some examples, the first band 604 and the second band 606 are positioned along a limb segment proximal to adjacent joints, such as the first band 604 positioned proximal to a wrist (first joint) and the second band 606 positioned proximal to an elbow (second joint). In a further example, the first band 604 may be positioned proximal to an ankle joint (first joint), and the second band 606 may be positioned proximal to a knee joint (second joint).

In some examples, the at least one actuator 608 may include two passive actuator modules that deliver both assistive and therapeutic torque to the joint. The actuator modules may function as remote-center-of-rotation passive elastic transmissions such that the actuator's rotation point is not located directly at the rotation axis but instead is mechanically encoded at a distance from the rotation axis, allowing the actuator to apply torque around the natural axis of the body part associated with the actuator (such as a forearm) without requiring additional hardware at the joint itself. The actuators may be joint agnostic such that the actuators may be generalized to any joint of the body.

The assistive actuator module may include an elastic cord wrapped helically around the body part (e.g., forearm) to generate supination torque and is mathematically modeled as a segmented spring network, incorporating stiffness profiles from tension-stretch tests of varying elastic cord lengths and diameters. An additional band (e.g., third band 110) may be placed into the system to firstly provide reduction of skin artifact or movement during device usage. The functionality of the assistance actuator module may be increased to allow for elbow-modulated assistance using the helically wrapped elastic cord. In this configuration as applied to the upper extremities, as the user extends the elbow, the user may receive more supination assistance, encouraging movements that assist in getting the user out of the flexion synergy seen after stroke.

In some examples, the therapeutic actuator module, inspired by camera shutter mechanics, uses rod actuators, which may be made of fiberglass, connected by one or more spring actuators to form a passive structure with a remote center of rotation that mimics radius-ulna motion (as one example) and produces nonlinear, phase-varying torque. As the user initiates rotation (e.g., supination), spring extension produces increasing resistive torque to encourage active effort. At a mechanically encoded transition point, the actuator geometry shifts the springs' mechanical advantage to reverse torque direction and assist beyond the active ROM. This resist-then-assist behavior promotes muscle engagement and supports task completion within a single motion. Benchtop and simulation results confirmed accurate torque-angle outputs, demonstrating the feasibility of motor-free actuation for assistive and therapeutic functions.

In some examples, the aforementioned actuators may be generalized to other applications outside the use on the forearm. The actuator modules may be generalized as passive elastic transmission pucks that can be attached to any system (passive or active), to bring the actuator functionality to other applications. The assistive bungee actuator may be generalized as a passive elastic transmission with potential applications in powered exoskeletons or robotic devices, enhancing motor efficiency and allowing the use of smaller, lighter actuators. This hybrid passive-active approach may accelerate the adoption of motorized rehabilitation technologies in home and community settings. The shutter-unstable equilibrium actuator is generalized as a passive elastic transmission for passive torque reversals with potential applications in robotic grippers (enabling object stabilization without continuous motor input), as well as in exoskeletons and therapeutic systems, extending impact across all robotic systems.

In some examples (such as the embodiment illustrated in FIGS. 5A-5C) the wearable components of the device 602 may be modular to support building-block-style actuation for simpler and/or faster reconfiguration. For example, the system 600 may include a 3D-printed forearm base component with flexible anchor such as the first band 604 and the second band 606 (e.g., wrist, forearm, and elbow) featuring custom dovetail rails that accept swappable actuator attachments. One or more actuators 608 (e.g., helical bungee assistance, shutter, bow-spring) may be assembled using interchangeable components tailored for specific functions (e.g., assistance and/or therapy). This “building block” design enables rapid reconfiguration without tools. The structure conforms to user anatomy, accommodates various body part sizes (forearm sizes), and provides secure mounting. Stroke survivors may benefit from the lightweight, comfortable, and unobtrusive nature of the system during movement.

This system 600 is joint-agnostic and can be applied for various torque functions across the body. For use in the forearm, the torque may be personalized according to the user's needs in order to compensate for torque deficits. Components of the system 600 may be fully swappable by the user while wearing the device 602. One or more of the components of the system 600 may be 3D printed.

Examples of the system 600 configured for upper-limb implementation, such as the forearm, are illustrated in the figures. In further examples, the system 600 may be configured for lower-limb implementation such as on a leg of the user. The wearable device 602 may include passive lower-limb exoskeleton designed to enhance both assistive and therapeutic rehabilitation applications, such as EA or gravity compensation. For example, the components of the device 602 may include one or more actuators, providing an adjustable resistance and assistance mechanism, selected based upon the user's unique rehabilitation needs, as well as an indexed mechanism with notches or teeth for precise incremental adjustments allowing for real-time adjustments of the moment arm length and angle while ensuring stability once set, which may be achieved via the GUI 612 that allows clinicians, care partners, or the users themselves to adjust the design and structure of the device 602 in real-time. The use of passive springs may ensure that the device is lightweight, portable, affordable, and safe to operate. Moreover, the device 602 does not require any charging or rebooting, providing a convenient and hassle-free solution for individuals with motor impairments.

The device 602 may include one or more actuators provided as a spring network system of elastic bands and stacked tension elements that significantly increase the elastic torque produced by the spring network system. For example, the stacked tension elements may significantly increase the elastic torque produced by the spring network system. This enhancement allows for greater support and adaptability, making it highly effective in addressing various levels of resistance needs across different rehabilitation and training applications. The device 602 may act as an exotendon storing elastic energy during movement and releasing the stored elastic energy to aid propulsion while allowing for free and natural limb motion. The configurations of the device 602 may be achieved via the GUI 612 that allows the user or the clinician to adjust the design and structure for the device in real-time. Different configurations can compensate for deficits like foot drop, provide support against gravity, and promote adaptive motor learning by exaggerating movement errors when desired. In some examples, the design of the device 602 aims to challenge users to stabilize against exaggerated ankle dorsiflexion and a change in leg propulsion forces during the swing phase of gait, and to assist users in movement when needed, facilitating controlled adaptive engagement to enhance rehabilitation. In some examples, the device 602 may be worn around the thigh as well, creating a comprehensive multi-joint network system that provides support and resistance across both the hip and knee joints, enhancing overall lower limb functionality.

The adaptability of the device 602 may replace the need for therapists to manually apply resistance bands and error augmentation gait therapy, making it ideal for both clinical and at-home use.

Existing devices often use rigid components to prevent common gait impairment such as foot drop (toe drag) by providing fixed ankle support and restricting plantarflexion in order to fix the ankle in a neutral or dorsiflexed position to ensure proper clearance during the swing phase. However, such rigid structures often limit natural movement, which can reduce overall adaptability and engagement of surrounding muscles during gait. In contrast, the device 602 as disclosed herein offers a flexible, adjustable approach to assist and enhance gait, allowing for more dynamic and customizable support without restricting natural joint movement. Moreover, the device 602 can be used to specifically target the recruitment and training of weakened leg muscles.

Also, existing devices that use springs or spring-like components to provide support and enable natural movement often lack an adjustable mechanism and are often limited to a single joint, thereby failing to incorporate multi-joint movements for a smooth and adaptive gait cycle. The fixed nature of such existing devices limits personalization and the ability to have precise adjustments based on the user's unique gait needs, as well as failing to place an emphasis upon its use for error augmentation and promotion of motor learning during gait rehabilitation. In contrast, the device 602 as disclosed herein operates as an assistive device to aid in gait rehabilitation thereby improving performance of ADLs. For lower limb (e.g., leg) rehabilitation, the device 602 supports independent gait training to enhance balance and prevent foot drop among other gait impairments, which is critical for stroke survivors and individuals with neurological impairments. Additionally, the device 602 serves a restorative function by strengthening muscles involved in gait, particularly through its customizable resistance and error augmentation features, which promote adaptive motor learning. Initially designed for stroke survivors with hemiparesis, the device 602 is capable of extending its applications to include individuals with spinal cord injuries (SCI), muscular dystrophy, and other neurological diagnoses, helping them achieve greater independence and stability during movement. The device 602 has versatility to be an ideal training tool for physical therapy clinics and athletic training, providing safe, effective support without requiring constant clinical supervision.

The algorithm for tailoring the selection and arrangement of the actuators around the user limb segment(s) comprises two main elements: (1) the mathematical device model representing the physical model of the body part and each actuator configuration, and (2) the optimization algorithm used to configure and tune the device.

### Mathematical Device Model

The mathematical device model is configured to physically model a limb segment (e.g., a forearm) of the wearer that is associated with one or more joints (e.g., a wrist joint and an elbow joint) and the behavior of each of the actuators in the wearable device given their intended purposes. Inputs to this model include dimensional measurements of each individual wearer, such as limb length (e.g., forearm length, upper arm length), limb diameter (e.g., forearm diameter), and joint diameter (e.g., wrist diameter). These inputs are measurements that can be taken from the clinician and input directly into the algorithm via a user interface, such as the GUI in communication with a data processing device. In addition, each individual's unique torque deficits (e.g., static supination torque at several positions, active supination torque, active and passive supination range of motion, grip strength, catch point identification, etc.) can be measured via diagnostic tools and known methods, and input into the algorithm. Other inputs for the mathematical model include the material properties for the actuators 106 (e.g., rod actuators, cord actuators, and springs). These properties include the tension stretch relationships, also known as the stiffness profiles for each of the actuators. Using these inputs, the limb segment (e.g., the forearm) of the user is simulated as a frustum in the code.

In some examples, mathematical model may replicate full parameterized state of the wearable device 602 and each tunable parameter thereof. For example, mathematical models for each actuator 608 may allow the optimization algorithm to tune every design parameter that can control the functionality of the actuator 608. For the helical elastic cord, as well as being able to represent the stiffness of the cord as with a single spring constant, the mathematical model may incorporate force-stretch relationships for each elastic cord type derived from experimental benchtop testing. The model may incorporate these experimentally validated force-stretch relationships directly into the mathematical model. The helical elastic cord may be mathematically modeled as a series of discrete spring segments along a helical path around the limb segment (e.g., forearm). This approach provides an accurate representation of the actuator's wrapping mechanics, enhancing the model's ability to simulate realistic behavior. The stretch of the elastic cord can be allocated to each discrete spring segment, therefore improving the modeling of the effects of friction or pinch-points on the bungee, for example.

In one example, the helical elastic cord actuator is represented using Hooke's Law. However, due to its unique wrapping behavior around the limb segment (e.g., forearm), the cord actuator is modeled as a helix where it is segmented into finite elements. In application of the device to the forearm, extension of these elements is recorded during the supination range of motion of the forearm, and then sum each of the finite elements'extension to create a force that is applied at the joint (wrist). This force is used to evaluate the torque induced by the actuator. This method is also used for the rod actuator. The model controls how the rod flexes based on experimental results and uses Hooke's Law to mathematically simulate the force and torque induced on the joint (wrist). The simply supported rod mathematical model utilizes a modification of the beam bending equations outlined by the double integration method found in literature. The shutter model uses simple Hooke's Law for linear, spring elements in combination with the movement of the rigid rods around the forearm affecting the tension/stretch relationships of the tension spring elements.

### Optimization

Once each of the actuator mathematical models are functioning properly and verified with experimental data, their models are converted into functions that can be called by the main loop of the code. These functions are inputted into the optimization algorithm which computes the optimal orientation and properties of each of the actuator types to be used to accommodate the specified torque profile of each unique wearer of the device. The optimization algorithm for the model can use two methods for optimization, the first being a gradient-based constrained optimization, and the second being an unconstrained, gradient-free optimization. Gradient-based constrained optimization relies on calculating the gradient (or slope) of the objective function to efficiently navigate towards an optimal solution while adhering to predefined constraints, such as parameter bounds or equality conditions. This approach is particularly effective when the objective function is smooth and differentiable, as it leverages information about how the function changes to make informed decisions about the next steps in the search for the optimum. The unconstrained, gradient-free optimization does not require the computation of gradients. Instead, it explores the parameter space more freely, often using random or heuristic-based techniques to find the optimal values. This method is useful for problems where the objective function may be discontinuous, noisy, or difficult to differentiate, and it allows for more flexibility in handling complex or poorly defined search spaces.

The same inputs that are used in the mathematical device model may also be used in the optimization model. In addition, a desired torque profile that is also input into the algorithm and represents the torque profile that the output configuration of actuators must combine to replicate. The desired torque profile may be based, at least in part on, the wearer's unique torque deficits, the needs and/or desired results of the wearer and a treatment plan or therapeutic outcome developed by a clinician. Further, the desired torque profile may be based on the wearer's measured torque deficits. The desired torque profile may be set solely by a clinician, or may be set based on clinician and wearer input, including patient treatment goals.

The parameters being optimized span various metrics of the system such as the actuator types and actuator properties (rod diameter, lengths, bungee stiffness, bungee diameter, actuator locations on the arm). The optimization model is based on the principles of basis functions, where each actuator provides a sinusoidal torque profile that can be linearly combined to create a custom torque profile. Using the model, the types and properties of actuators are selected such that the linear summation matches the torque deficit profile of the user. Each user's deficit is calculated as the neurotypical average for strength values subtracted from the torque the user can produce on their own. The optimized parameters are then fed into the mathematical models to calculate the produced torques of the joint movement device and what is needed to counteract the torque deficit of the subject. In some examples, the output of the algorithms may be instructions for the user and/or clinician to configure the wearable joint movement device, which may include selection (e.g., type, number, diameter, length and stiffness, etc.) and placement of one or more actuators on both the first and second bands.

The GUI 612 may provide an interface for inputting various measurements the optimization algorithm. In one example, the GUI may be used by clinicians treating wearers of the device or by researchers conducting clinical trials. The GUI may include fields to input wearer information, including wearer information, including arm measurements and whether the device will be worn on the left versus right arm; wearer torque deficit; and the desired torque profile of the wearer's forearm. The output of the optimization algorithm may also be sent to and displayed on the GUI for interpretation by a user or clinician. In some examples, the data processing device may transmit instructions for selecting a configuration of at least one actuator element to the GUI.

In some examples, structural optimization may be employed to tune the number of actuators and all associated design parameters. For example, the optimization may include the ability to tune the number of actuators 608 which may include, but are not limited to, number of bungee cords, number of bow-springs, number of shutter rods, number of shutter springs, etc. Each actuator module has a set of design parameters that determines the amount and type of torque that it can produce. For example, the helical bungee has 8 design parameters and the shutter actuator has 15 design parameters. By allowing the optimization to optimize for the number of actuators 608, the system 600 is able to iteratively scale up the design space to accommodate the increased number of actuators 608. For example, evaluating a single helical bungee with a single shutter actuator containing a single spring yields a design space of 23 variables. However, if the optimization is allowed to explore solutions up to 5 helical bungee cords and 5 shutter actuators with up to 5 springs in each shutter actuator module, then the design space grows to over 140 dimensions.

In some examples, structural optimization framework may personalize the design of the system 600 to fully compensate individual torque deficits. A structural optimization algorithm may customize configurations of the actuator 608 based on user-specific torque deficits. The fully parameterizable design of the actuator 608 enables tuning of over 150 design variables, including spring number, placement, and resting length, to match target torque-angle profiles derived from diagnostic data. The parameters are tuned via a hybrid multi-stage optimization approach which identifies and minimizes error between desired and predicted torque output. The hybrid multi-stage optimization approach combines global optimization tools (e.g., genetic algorithm), gradient-based local solvers (e.g., MATLAB's “fmincon” program which is a program for finding a minimum of a constrained nonlinear multivariable function), probabilistic global refinement (e.g., simulated annealing), and a second global refinement (e.g., MATLAB's “patternsearch” program which is a program for finding a minimum of a function using pattern search). Pilot testing has confirmed the algorithm successfully generated system configurations that accurately compensated measured deficits (R²=0.987 for assistance and R²=0.987 for shutter).

For example, the pipeline begins by quantifying each stroke participant's torque deficit profile by subtracting each stroke participant's baseline evaluations from a neurotypical average using the diagnostic tool. Using this torque deficit curve as the primary input (desired torque profile) into the optimization, the algorithm determines system configurations using any combination of actuators 608 (e.g., helical bungee for assistance, shutter actuator for unstable equilibrium, or rod for assistance) or each actuator alone to replicate the desired torque profile. To reduce convergence time (of which the prior approach required 8-13 hours), the optimization algorithm is restructured into a multi-stage pipeline with a convergence time of 8-10 minutes.

First, a genetic algorithm explores the solution space for relatively good solutions evaluated using R² and root mean square error (RMSE) between desired torque profile and the torque profile of the current system configuration. Once a good candidate solution is determined, the latent variables (all design variables not associated with the current number of actuators) are locked. In order for the optimization to run, the design space is allocated for the maximum number of actuators (e.g., about 150 design parameters); however, based on the number of actuators determined by the optimization, the design parameters are “turned off” for the actuators that do not exist in the configuration. Once a solution is identified, the variables for the actuators that are not in the configuration are locked to avoid any stalling of the optimization, thereby reducing the design space by at least 10 dimensions, at least 50 dimensions, or at least 100 dimensions, such as from 150 dimensions down to 30 dimensions, for example.

The identified solution is subsequently used in a second global optimization tool, such as the simulated annealing. The simulated annealing approach refines candidate solutions via probabilistic acceptance (e.g., a Metropolis acceptance criterion) of worse solutions. The simulated annealing will randomly try different system configurations and evaluate the corresponding torque output curves with the desired torque deficit curve. The approach will accept worse solutions to avoid settling in a local minimum. The accepted solutions undergo a local gradient-based optimization, for example by using MATLAB's “fmincon” program, to fully explore the design space in the region of that solution to identify if better solutions exist around this specific combination of tunable parameters. Once the simulated annealing is complete, a final global refinement is completed, for example by using MATLAB's “patternsearch” program, to perform a final check to confirm whether the current system configuration is indeed the best solution.

In some examples, the optimization cost function may incorporate new or additional constraints. For example, the optimization may be evaluated using R² and RMSE between desired torque profile and the torque profile of the current system configuration. The cost function responsible for this evaluation may include new constraints to ensure the system configurations that are being recommended are solutions that are realistic and can be constructed. For example, a first constraint may be implemented to be used to encourage simpler and less cumbersome system designs by penalizing the cost function with a penalty term proportional to the number of actuators in the system configuration. A second constraint may be implemented to be used to promote safety, feasibility, and repeatability of the actuator where actuator lengths are constrained within acceptable physical limits (e.g., within elastic limit). If an actuator's length exceeds the maximum allowed length (e.g., 2-3 times of the resting length) or falls below the minimum allowed length (e.g., the resting length), a penalty may be incurred. A third constraint may be implemented to be used to prevent actuators from intersecting with the user's body part, such as the forearm (which may be modeled as a frustum with elliptical ends). A penalty may be applied when collisions are detected which is determined by sampling coordinates along each actuator and the body part (forearm) and comparing them to identify if they share the same space. The penalty incurred by this penalty may be proportional to the degree of intersection of the sampled points.

It is to be understood that the biomechanic principles of using tension and/or compression elements at the joints to provide assistance and/or therapy and the use of an algorithm for optimizing the desired effects, as disclosed herein, may be applied to any joint, including but not limited to wrist, elbow, shoulder, ankle, knee, hip, etc.

In one exemplary application, a stroke subject's torque deficit curves may be employed for varying levels of assistance. For example, each stroke subject's torque deficit curve derived from the diagnostic tool and used as the primary input for the optimization may be modified in an updated algorithm GUI. Such update may allow the user to determine whether to allow the device 602 to provide 10-100% supination assistance or, if the user would like to use the shutter actuator, then 5-50% resistance in the working range of motion and then 10-100% assistance past the movement limit.

In some examples, the system 600 may offer interchangeable modes, such as (A) an “assistive mode” in which elastic elements are routed to generate an assistive torque that modulates as the user extends the joint (elbow), providing intuitive, motion-coupled support for limb (forearm) supination, and (B) a “therapeutic mode” featuring the unstable equilibrium actuator that initially resists movement within the user's active range but subsequently reverses torque to assist once the natural motion limit of the user is reached, thereby encouraging engagement and facilitating task completion. These modes may be selected via the GUI and implemented by the optimization algorithm.

### Methods

A method of joint movement assistance and therapy is also provided herein. In a first step, a wearable joint movement device including a first band, a second band and at least one actuator element is provided. As described herein, the at least one actuator element will generate a torque profile between the first band and the second band, when connected. Depending on the configuration, the actuator will utilize one or both of a state of stable equilibrium or a state of unstable equilibrium while the wearer moves their forearm in supination.

In a second step, a data processing device configured to execute one or more algorithms is provided. The one or more algorithms can include a device model for modelling the wearer's arm and the behavior of each of the one or more actuators in each possible configuration of the actuators on the device, and an optimization algorithm for determining the optimal configuration of each of the one or more actuators on the device. The data processing device has access to data regarding the various types of actuators (e.g., rod actuators, cord actuators, and tension springs) that may be used in the device, the dimensions of the possible actuators (e.g., length, diameter, thickness), the material properties of those actuators (e.g., stiffness profiles) and mathematical principals that may be used to simulate the behavior of the actuators.

In a next step, the data processing device collects measurement data of the body part of the user (e.g., forearm length, forearm diameter, wrist diameter, and upper arm length and diameter), the user's torque deficit and a desired torque profile for the user. Next, based on the at least one algorithm and the collected data, the data processing device generates instructions for configuring the at least one actuator element. These instructions may include selection of the type and size of the at least one actuator element, and how the at least one actuator is to be connected to the first band and the second band. A user or clinician may use these instructions to configure the device.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

What is claimed is:

1. A system for joint movement assistance and therapy, the system comprising:
a wearable joint movement device attached noninvasively to a user, the wearable joint movement device comprising:
a first band, configured to be removably attached on a limb of a user proximal of a first joint of the user;
a second band, configured to be removably attached on the limb of the user distal of a second joint of the user; and
at least one actuator element configured to connect at a first end to the first band and at a second end to the second band and to generate a torque profile between the first band and the second band such that a limb portion of the user moving in rotation is in one or both of a state of stable equilibrium and a state of unstable equilibrium; and
a data processing device configured to:
collect data indicative of a torque deficit of the limb of the user;
collect measurement data of the limb of the user;
collect a desired torque profile for the wearable joint movement device; and
generate, based on the data indicative of the torque deficit of the limb of the user, the measurement data and the desired torque profile, and using at least one algorithm, instructions for selecting a configuration of the at least one actuator element.

2. The system of claim 1, wherein the at least one actuator element comprises at least one selected from a group of: rod actuator, elastic cord actuator and tension spring.

3. The system of claim 1, wherein the configuration of the at least one actuator element comprises: a number of the at least one actuator element, a location at which a first end of the at least one actuator element is connected to the first band and a location at which a second end of the at least one actuator element is connected to the second band, and a stiffness profile of the at least one actuator element.

4. The system of claim 3, wherein:
the at least one actuator element comprises at least one rod actuator and at least one spring actuator; and
the configuration of the at least one actuator element comprises:
a first rod actuator connected at a first end to the first band and at a second end to the second band;
a second rod actuator connected at a first end to the first band and at a second end to the second band;
wherein the first rod actuator is laterally spaced apart from the second rod actuator; and
wherein the at least one spring actuator is connected at a first end to the first rod actuator and at a second end to the second rod actuator.

5. The system of claim 3, wherein:
the at least one actuator element comprises at least one rod actuator and at least one cord actuator; and
the configuration of the at least one actuator element comprises:
a first rod actuator connected at a first end to the first band and at a second end to the second band;
a second rod actuator connected at a first end to the first band and at a second end to the second band;
wherein the first rod actuator is laterally spaced apart from the second rod actuator; and
a cord actuator connected at a first end to the first band and at a second end to the second band and wrapped at least one time around the limb portion of the user therebetween.

6. The system of claim 3, wherein the at least one actuator element comprises at least one rod actuator and at least one cord actuator.

7. The system of claim 6, wherein the configuration of the at least one actuator element comprises:
a first rod actuator connected at a first end to the first band and at a second end to the second band;
a second rod actuator connected at a first end to the first band and at a second end to the second band;
wherein the first rod actuator is laterally spaced apart from the second rod actuator; and
a cord actuator wrapped at least one time around the limb portion of the user and the first and second rod actuators.

8. The system of claim 6, wherein the configuration of the at least one actuator element comprises:
a first rod actuator connected at a first end to the first band and at a second end to the second band;
a second rod actuator connected at a first end to the first band and at a second end to the second band;
wherein the first rod actuator is laterally spaced apart from the second rod actuator; and
a cord actuator connected at a first end to the first band and at a second end to the second band and wrapped at least one time around the limb portion of the user and the first and second rod actuators therebetween.

9. The system of claim 3, wherein:
the at least one actuator element comprises at least one cord actuator; and
the configuration of the at least one actuator element comprises:
a first cord actuator connected at a first end to the first band and at a second end to the second band; and
a second cord actuator connected at a first end to the first band and at a second end to the second band;
wherein the first cord actuator is laterally spaced apart from the second cord actuator at both the first band and the second band;
wherein each of the first cord actuator and the second cord actuator are wrapped around the limb portion of the user between the first band and the second band.

10. The system of claim 1, wherein the measurement data of the limb comprises at least one selected from a group of: length of the limb portion of the user, diameter of the limb portion of the user, diameter of the first joint of the user, length of an upper limb of the user and diameter of the upper limb of the user.

11. The system of claim 1, further comprising a graphical user interface in communication with the data processing device.

12. The system of claim 11, wherein the data processing device is further configured to transmit the instructions for selecting a configuration of the at least one actuator element to the graphical user interface.

13. The system of claim 1, wherein the at least one algorithm comprises:
a device model for modeling the torque profile of the at least one actuator element in each possible configuration of the device; and
an optimization model for optimizing the configuration of the at least one actuator element on the joint movement device to achieve the desired torque profile.

14. The system of claim 1, wherein the limb is an arm of the user, the first joint is a wrist joint of the user, and the second joint is an elbow joint of the user.

15. The system of claim 1, wherein the limb is a leg of the user, the first joint is an ankle joint of the user, and the second joint is a hip joint of the user.

16. The system of claim 1, wherein the limb is a leg of the user, the first joint is an ankle joint of the user, and the second joint is a knee joint of the user.

17. A method of joint movement assistance and therapy comprising:
providing a wearable joint movement device configured to be attached noninvasively to a user, the wearable joint movement device comprising:
a first band, configured to be removably attached on a limb of a user proximal of a first joint of the user;
a second band, configured to be removably attached on the limb of the user distal of a second joint of the user; and
at least one actuator element configured to connect at a first end to the first band and at a second end to the second band and generate a torque profile between the first band and the second band such that a limb portion of the user moving in rotation is in one or both of a state of stable equilibrium and a state of unstable equilibrium;
providing a data processing device configured to:
collect data indicative of a torque deficit of the limb of the user;
collect measurement data of the limb of the user;
collect a desired torque profile for the wearable joint movement device; and
generate, based on the data indicative of the torque deficit of the limb of the user, the measurement data and the desired torque profile, and using at least one algorithm, instructions for configuring the at least one actuator element; and
based on the instructions, connecting the first end of the at least one actuator element to the first band and a second end of the at least one actuator element to the second band.

18. The method of claim 17, further comprising: based on the instructions, selecting the at least one actuator element from a group of: rod actuator, elastic cord actuator and tension spring.
